(19) United States
(12) Patent Application Publication
(10) Pub. No.: US 2026/0109055 A1
(43) Pub. Date: Apr. 23, 2026

(54) FLEXIBLE FINGER COMPONENTS

(71) Applicant: Boston Dynamics AI Institute LLC, Cambridge, MA (US)

(72) Inventor: Osman Dogan Yirmibesoglu, Medford, MA (US)

(21) Appl. No.: 18/921,155

(22) Filed: Oct. 21, 2024

(51) Int. Cl. B25J 15/12

(52) U.S. Cl. CPC B25J 15/12

(57) ABSTRACT

A robotic system comprises a support structure and flexible fingers. A first end of a first flexible finger is fastened to the support structure and an additional first end of a second flexible finger is fastened to the support structure. The first flexible finger includes a flexible support member on an outer surface of the first flexible finger and a plurality of flexible beams disposed on a respective plurality of positions located along an interior surface of the first flexible finger. A first subset of the plurality of flexible beams are oriented relative to a first plane and a second subset of the plurality of flexible beams are oriented relative to a second plane.

### TECHNICAL FIELD

The subject matter described herein relates generally to the design and operation of flexible fingers, e.g., for robotic systems.

### BACKGROUND

Robotic systems are complex, constantly evolving, and frequently utilized to perform a variety of simple and complex tasks in a number of industries such as manufacturing, construction, warehouse operation, medicine, transportation, and so forth. While these systems have experienced significant technological improvements, various challenges remain. One such challenge relates to the gripping capabilities of these systems, namely the ability of these systems to effectively grasp and maintain contact with objects of various dimensions.

### SUMMARY

In aspects, a robotic system is contemplated. The robotic system can comprise a support structure, a first flexible finger, and a second flexible finger. In aspects, a first end of the first flexible finger can be fastened to a location on the support structure and an additional first end of the second flexible finger can be fastened to an additional location on the support structure. The first flexible finger can include a flexible support member disposed on a portion of an outer surface of the first flexible finger and which can extend from the first end of the first flexible finger to a location on the outer surface of the first flexible finger. The first flexible finger can also include a plurality of flexible beams disposed on a respective plurality of positions located along an interior surface of the first flexible finger. Each of a first subset of the plurality of flexible beams can be oriented relative to a first plane and each of a second subset of the plurality of flexible beams can be oriented relative to a second plane.

In aspects, another robotic system is contemplated. The robotic system can comprise a support structure, a first flexible finger and a second flexible finger. A first end of the first flexible finger can be fastened to a location on the support structure and an additional first end of the second flexible finger can be fastened to an additional location on the support structure. In aspects, the first flexible finger can include a flexible support member disposed on a portion of an outer surface of the first flexible finger and can extend from the first end of the first flexible finger to a location on the outer surface of the first flexible finger. The first flexible finger can include a plurality of flexible beams disposed on a respective plurality of positions located along an interior surface of the first flexible finger.

In aspects, a flexible robotic finger is contemplated. The flexible robotic finger can comprise flexible beams disposed on a respective plurality of positions located along interior surfaces of the flexible robotic finger. An end of each of the flexible beams can be disposed on a first interior surface of the interior surfaces of the flexible robotic finger and another end each of the flexible beams can be disposed on a second interior surface of the interior surfaces of the flexible robotic finger. Each of a first subset of the flexible beams can be oriented relative to a first plane and each of a second subset of the flexible beams can be oriented relative to a second plane.

### BRIEF DESCRIPTION OF THE FIGURES

FIG. 1A illustrates an example of a robotic finger mechanism of the present disclosure, according to some aspects described and illustrated herein;

FIG. 1B depicts an expanded view of multiple sections of a first flexible finger, according to some aspects described and illustrated herein;

FIG. 1C depicts an expanded view of a plane change region, according to some aspects described and illustrated herein;

FIG. 2A depicts an illustration of an extended position of the robotic finger mechanism, according to some aspects described and illustrated herein;

FIG. 2B depicts the robotic finger mechanism of the present disclosure grasping and maintaining contact with an external object, according to some aspects described and illustrated herein;

FIG. 3A depicts the robotic finger mechanism grasping and maintaining contact with an example object, according to some aspects described and illustrated herein;

FIG. 3B illustrates an example operation of the robotic finger mechanism, according to some aspects described and illustrated herein;

FIG. 4 depict another example aspect or configuration of the robotic finger mechanism, according to some aspects described and illustrated herein;

FIG. 5A depicts a side view of an example flexible finger of the present disclosure, according to some aspects described and illustrated herein;

FIG. 5B depicts a front view of an example flexible finger of the present disclosure, according to some aspects described and illustrated herein;

FIG. 6 depicts another example flexible finger of the robotic finger mechanism of the present disclosure, according to some aspects described and illustrated herein;

FIG. 7 depicts another example flexible finger of the robotic finger mechanism of the present disclosure, according to some aspects described and illustrated herein; and

FIG. 8 illustrates a schematic diagram of an example computing system that can correspond to a microprocessor configured to control operation of the flexible fingers, according to one or more aspects described and illustrated herein.

### DETAILED DESCRIPTION

Robotic systems are prevalent across a wide range of industries such as manufacturing, energy and resource extraction, construction, medicine, transportation, and so forth. The systems operating within these respective industries have varying capabilities and complexities. However, a common challenge faced by at least some of these systems involves effectively grasping and maintaining contact with one or more objects of various shapes and sizes without changing one or more end-effectors of these systems.

The types of robotic systems described herein have a number of advantages. In particular, some implementations include a couple of flexible robotic fingers that operate such that one of these flexible fingers (e.g., a top finger) can preferentially buckle (e.g., deform) when contacting an object that is asymmetric to the robotic system while also effectively resisting vertical pressure that may result from grasping an asymmetric object (e.g., disproportionately large object). This capability prevents premature failure of the robotic system (e.g., damage to one of the fingers, losing contact with an external object, and/or an action that can be defined as an incorrect or unintended operation of the robotic finger)—a distinct advantage over conventional robotic systems. A design of the top finger can include at least two sections such that (1) a section includes a plurality of flexible beams that conform to a configuration such that each flexible beam aligns with a first planar region (e.g., a first plane), and (2) a second plurality of flexible beams that conforms to another configuration such that each flexible beam aligns with a second planar region (e.g., a second plane). The second planar region is different from the first planar region.

In some implementations, the top finger also includes an additional layer of flexible material (e.g., a spinal layer) disposed on an outer surface of the top finger that serves as a thickening agent for improving the stability and sturdiness of the robotic system. Further, in aspects, the robotic system includes nail sections disposed on ends of the flexible robotic fingers (e.g., edges of the flexible fingers upon which an adhesive material such as, e.g., an adhesive tape, can be positioned). These nail sections can include flat surfaces that enable the establishment of firm contact with the surfaces of various objects such that the contact with these objects is maintained at both low torque and high torque levels (e.g., torque levels at which the fingers move can be based on, e.g., an actuator or motor of the robotic system, which drives the movement of the fingers). In aspects, the robotic system can also include a gap disposed between the flexible fingers, which provides the system with additional storage capability, which in turn improves the ability of the robotic finger mechanism to grasp and maintain contact with objects having dimensions that are disproportionate to the dimensions of the robotic system. In aspects, the robotic system can also include a support protrusion that contacts a portion of the top flexible finger and provides additional stability to this finger. In aspects, multiple flexible fingers, e.g., both the top and the bottom flexible fingers, can include an additional layer of flexible material (i.e. the spinal layer) disposed on their respective outer surfaces. Further, in aspects, a support protrusion can contact a portion of the top flexible finger and the bottom flexible finger.

The above described features, namely (1) a flexible finger (e.g. a top finger) with sections (with flexible beams) aligned with respect to different planar surfaces, (2) an additional flexible layer (e.g., a spinal layer disposed on a top surface of the top finger), (3) nail sections, (4) a support protrusion, and (5) a gap, provides the robotic finger mechanism described herein with a distinct set of advantages over conventional robotic system. Specifically, at least some of these features, operating independently and/or in combination, enable the robotic finger mechanism (1) to control the top finger such that sections of the top finger deform in accordance with a linear configuration that, in part, enables the mechanism to resist more vertical pressure exerted by objects grasped by the mechanism (as compared conventional robotic systems). The robotic finger mechanism described herein also provides the advantage of (2) passive compliance, which involves allowing preferential buckling or bending, which in turn reduces the likelihood of the robotic mechanism suffering damage, losing contact with an external object, and so forth, and (3) the establishment and maintenance of contact with objects of various shapes and sizes (e.g., due to the flat surfaces on the nail sections which allow the mechanism to perform complex tasks that cannot be performed effectively by conventional robotic systems, e.g. grasping large objects or objects with thin surfaces (e.g., paper plates, cups, etc.). These (and other advantages described in the present disclosure) are distinct advantages that are absent from conventional robotic systems.

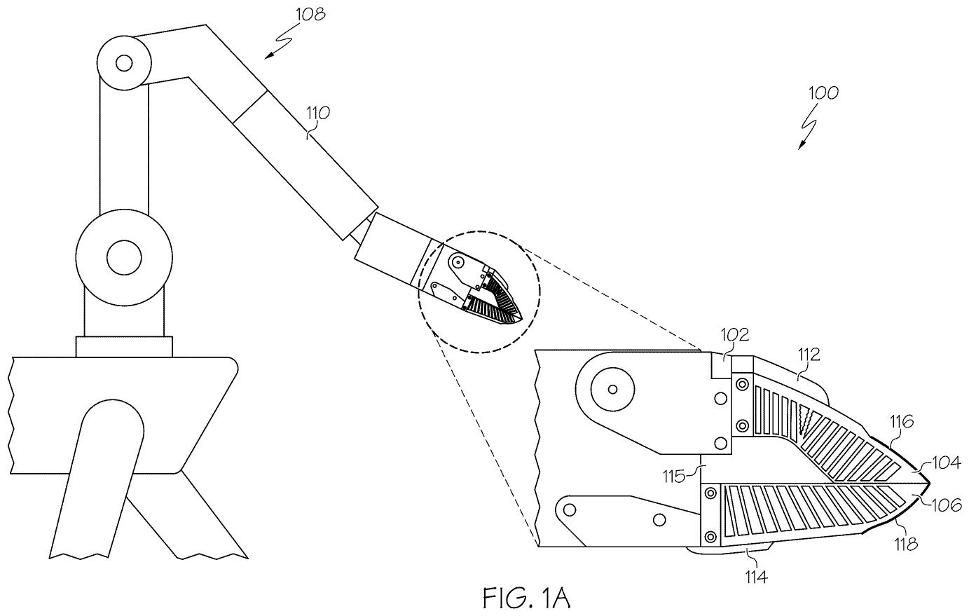

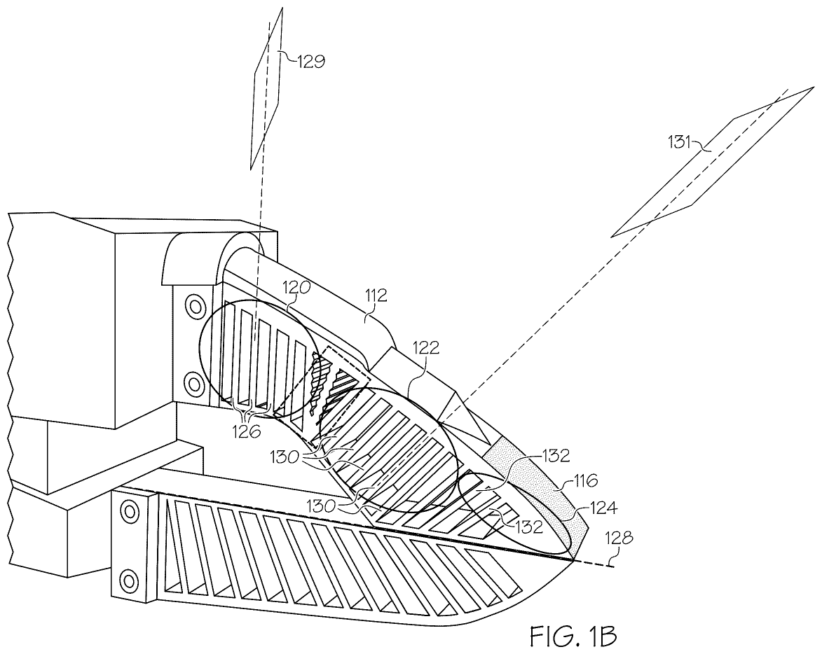

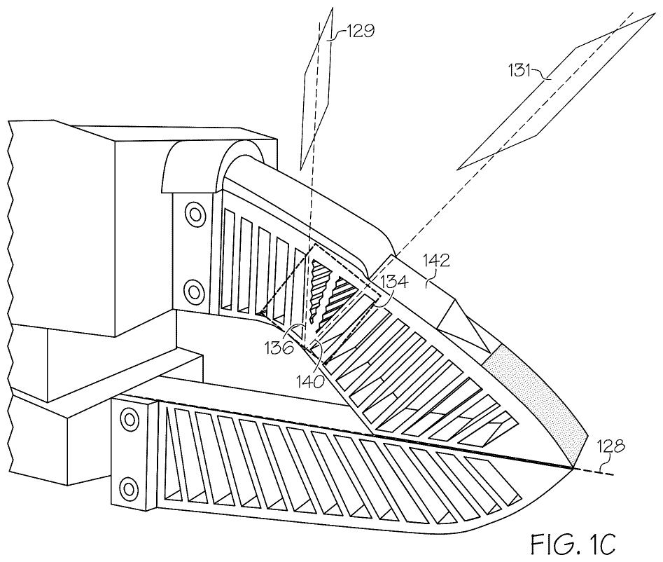

FIG. 1A illustrates an example of a robotic finger mechanism 100, in accordance with some aspects described and illustrated herein. The robotic finger mechanism 100 can include a plurality of flexible fingers operable to contact, grasp, and maintain control over external objects of various shapes and sizes. For example, these fingers can contact, grasp, and retain their grasp over external objects having dimensions that are comparable to and/or disproportional to the dimensions of the flexible fingers. In aspects, the robotic finger mechanism 100 also includes a support structure 102 with multiple apertures such that each flexible finger (e.g., a first flexible finger 104 and a second flexible finger 106) can be disposed within or in relation to a respective one of the multiple apertures. In aspects, the support structure 102 can be formed of, e.g., a carbon filled or micro carbon filled nylon filament. In aspects, the support structure 102 can be manufactured using a three-dimensional (3D) printing process.

For example, each of the flexible fingers can be attached to each respective one of the apertures using one or more adhering components, e.g., nuts, bolts, screws, adhesives, or a combination thereof. In aspects, as illustrated in FIG. 1A, the support structure 102 can correspond to a wrist component disposed on an appendage of a robot 108, e.g., appendage 110. In aspects, the appendage 110 corresponds to an arm of the robot 108 operable to move in various directions, vertically, horizontally, diagonally, rotationally, and so forth. Further, the first flexible finger 104 and the second flexible finger 106 can operate such that these fingers can move towards and away from one another while the appendage 110 remains stationary, e.g., similar to the manner in which human fingers function relative to a human arm. In aspects, the support structure 102 can include a support protrusion 112 that extends from a part of the support structure 102 in a direction that is parallel to the first flexible finger 104. In aspects, another support protrusion (additional support protrusion 114) that is similar to the support protrusion 112 can extend from a part of the support structure 102 in a direction that is parallel to the second flexible finger 106.

Additional details regarding the operation and functionality of the support protrusion 112 will be described in greater detail later on in this disclosure. In aspects, each of the first flexible finger 104 and the second flexible finger 106 can include a nail section or a tip section upon which an adhesive material such as, e.g., a first multipurpose adhesive tape 116 and a second multipurpose adhesive tape 118, respectively, can be positioned. The adhesive material improves friction relative to a surface (a surface of an external object) and increases a gripping capability of the first flexible finger 104 and the second flexible finger 106 relative to a surface of an external object. Further, the nail section, having a nonhollow geometric design, has a rigidity or stiffness that is higher than the rigidity or stiffness of other portions of the first flexible finger 104 and the second flexible finger 106.

Each of the first flexible finger 104 and the second flexible finger 106 can be formed of a flexible material, e.g., thermoplastic polyurethane (TPU), such that each finger deforms upon contacting one or more surfaces of one or more objects. In aspects, each flexible finger can be formed of a material or a composite of one or more materials with properties comparable to TPU, namely an elasticity property comparable to TPU. The first flexible finger 104 and the second flexible finger 106 can be generated via implementation of a 3D printing process, traditional manufacturing processes, or a combination thereof. Other comparable processes and manufacturing techniques are also contemplated. Further, the robotic finger mechanism 100 can include a gap 115 disposed in between the first flexible finger 104 and the second flexible finger 106. The gap 115 provides the robotic finger mechanism 100 with additional object storage and placement capability, which in turn improves the ability of the robotic finger mechanism 100 to grasp and maintain contact with disproportionate objects—a distinct advantage over current robotic finger mechanisms. In aspects, the first flexible finger 104 can be designed and generated such that it has three separate and distinct sections, as indicated in FIG. 1B and described in greater detail below.

FIG. 1B depicts an expanded view of multiple sections of the first flexible finger 104, according to some aspects described and illustrated herein. In aspects, the first flexible finger 104 can include a first section 120, a second section 122, and a third section 124. The first section 120 corresponds to a portion of the first flexible finger 104 that is positioned directly underneath the support protrusion 112 such that the support protrusion 112 extends from an end of the first section 120 to a location that is proximate to another end of this section. In aspects, the support protrusion 112 can vary in thickness and in length such that the support protrusion can extend from an end of the first section 120 (e.g., an end proximate to one of the multiple apertures) to a part of the second section 122. The first section 120 can comprise a first set of flexible beams 126 that connect two parts of this section. The first set of flexible beams 126 can be oriented such that each of the flexible beams 126 are oriented at a similar or substantially the same angle relative to the axis 128. For example, each of the flexible beams 126 can be oriented vertically in accordance with an angle that is perpendicular or substantially perpendicular to the axis 128, as shown in FIG. 1B. In aspects, adjacent to the first section 120 is a portion of the first flexible finger 104 in which a set of beams are oriented such that there can be a change in a plane of at least one of these beams with respect to another one of these beams, as illustrated in FIG. 1C and described in greater detail below. For example, in aspects, each beam in the first set of flexible beams 126 can align with a plane (e.g., a first planar region 129).

Further, the second section 122 includes a second set of flexible beams 130, each of which can align with another plane (e.g., a second planar region 131) that is separate and distinct from the first planar region 129. In other words, the first set of flexible beams 126 can be aligned with the first planar region 129 and the second set of flexible beams 130 can be aligned with the second planar region 131. Finally, a third section 124 includes a third set of flexible beams 132, which can be oriented in accordance with an iterating angle configuration. The iterating angle configuration in the third section 124, in part, enables the robotic mechanism 100, specifically the first flexible finger 104 and the second flexible finger 106, to better grasp external objects. In other aspects, the third set of flexible beams 132 can be oriented in accordance with a configuration such that the angle at which these beams are oriented vary from the angles at which the beams in the first section 120 and the second section 122 are oriented (e.g., slight variance (e.g., 5% variance)) from the angles at which the beams in the second section 122 are oriented and significant variance from the angles at which the beams in the first section are oriented (e.g., aligned along a different plane).

FIG. 1C depicts an expanded view of a plane change region 134, according to some aspects described and illustrated herein. Specifically, as illustrated in the plane change region 134, a first plane change region beam 136 can be oriented along the first planar region 129 and a second plane change region beam 140 can be oriented along an entirely different plane (e.g., the second planar region 131). Further, the robotic finger mechanism 100 includes a spinal layer 142 (e.g., a flexible support member) that can be built as part of the first flexible finger 104 such that the spinal layer 142 is disposed on a part of an outer surface of the first flexible finger 104 and extends from an end of this finger, namely the end that is fixed within one of the multiple apertures of the robotic finger mechanism 100. Further, the spinal layer 142 tapers to a point towards the end of the second section 122. In aspects, the spinal layer 142 can extend from the end fixed within one of the multiple apertures on the support structure 102 to at least a part of the section 122. In aspects, the spinal layer 142 may not extend to a portion of the first flexible finger 104, which provides a threshold level of flexibility to various parts of the first flexible finger 104 while simultaneously providing support and stability for parts of the first flexible finger 104.

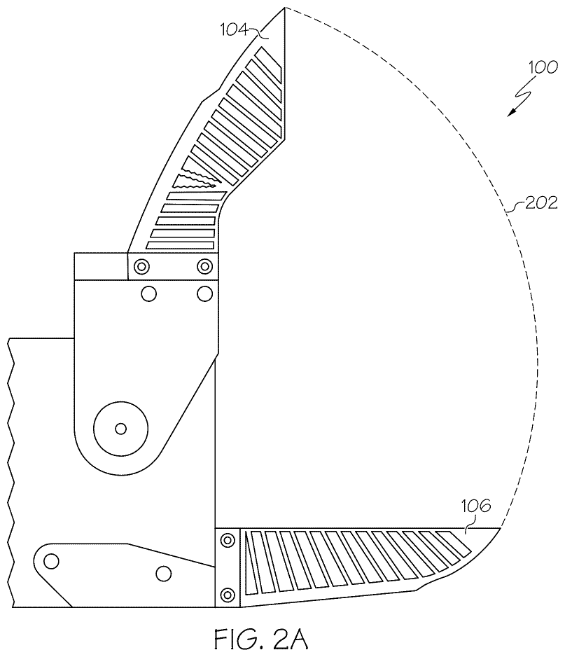

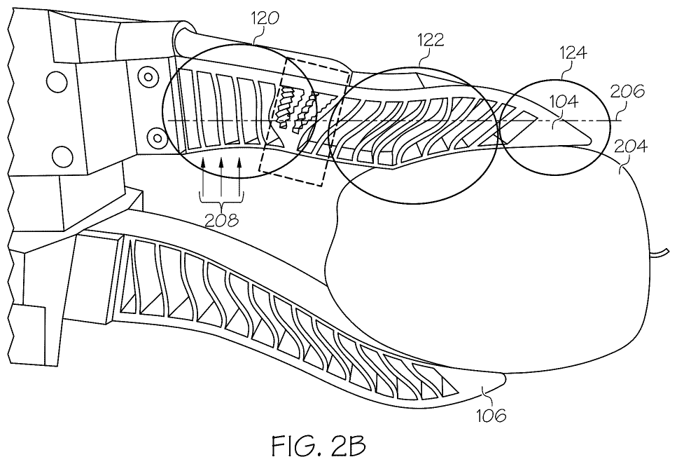

FIG. 2A depicts an extended position of the robotic finger mechanism 100, according to some aspects described and illustrated herein. Specifically, a maximal position 202 corresponds to a maximum amount that the first flexible finger 104 and the second flexible finger 106 can move relative to each other in order to accommodate and grasp an external object.

FIG. 2B depicts the robotic finger mechanism 100 of the present disclosure grasping and maintaining contact with an external object, according to some aspects described and illustrated herein. Specifically, FIG. 2B depicts the behavior of the robotic finger mechanism 100 while the mechanism grasps and maintains contact with an external object, e.g., an example object 204, that has dimensions that are disproportional to (e.g., larger than) the dimensions of the robotic finger mechanism 100. As illustrated, the first flexible finger 104 and the second flexible finger 106, contact an exterior surface of the example object 204.

Further, the flat surfaces of the nail section of the robotic finger mechanism 100 (upon which the first multipurpose adhesive tape 116 and the second multipurpose adhesive tape 118 can be disposed) enable the robotic finger mechanism 100 to, in part, establish and maintain firm contact with the external object 204. Further, the beams of the plane change region 134, namely the first plane change region beam 136 and the second plane change region beam 140, being oriented along different planar regions, enable the first flexible finger 104 and the second flexible finger 106 to adapt and conform to the shape of the external object 204, in this case, a substantially spherical object. In operation, as torque is applied (e.g., by a motor or actuator included as part of the robot 108 (illustrated in FIG. 1A), the first flexible finger 104 and the second flexible finger 106 can expand from a default resting position (closed position) to an open position. As the fingers open due to the application of torque (by one or more motors of the robot 108), the first set of flexible beams 126 included as part of the first section 120, the second set of flexible beams 130 included as part of the second section 122, and the third set of flexible beams 132 of the third section 124 can be in alignment with a flat configuration along line 206. Further, the presence of the spinal layer 142 provides an additional layer of thickness that improves the strength of the first flexible finger 104, which helps the robotic finger mechanism 100 maintain contact with the external object 204—a distinct advantage over conventional robotic fingers. In aspects, both the first flexible finger 104 and the second flexible finger 106 can include an additional layer of thickness (e.g., the spinal layer 142) that provides both fingers with an additional layer of thickness. The plurality of beams included in the first section 120 and the second section 122, operating in conjunction with the spinal layer 142, function such that these layers resist vertical forces 208 (indicated by the vertical arrows in FIG. 2B) that can result from contact with the external object 204. As such, the robotic finger mechanism 100 as described herein can be more resistant to failure when contacting an external object 204.

As illustrated in FIG. 2B, the plurality of beams in the first section 120 remain largely undeformed, and as such, resist vertical pressure from the external object 204, due in part to the spinal layer 142 and the support protrusion 112. In contrast, the beams in the second section 122 deform and absorb more of the vertical pressure from the external object 204. In short, the flexible beams in the second section 122 and the third section 124 bend or deform more than the beams in the first section 120. Further, as the first flexible finger 104 and the second flexible finger 106 contact the outer surface of the example object 204 and accommodate the entire volume of the example object 204, the first flexible finger 104 preferentially buckles or bends, particularly during application of large torque levels, to achieve a flat configuration in alignment with line 206. The deforming of the beams in the second and third sections 122, 124, in combination with the lack of deformation of the beams in the first section 120 provide the benefit of preventing the robotic finger mechanism 100 from prematurely and unexpectedly failing (e.g., losing contact with an object, suffering damage, etc.).

Further, the flat surfaces of the nail sections of the first flexible finger 104 and the second flexible finger 106, upon which adhesive tapes can be disposed (the first multipurpose adhesive 116 and the second multipurpose adhesive tape 118), contact the external surface of the example object 204. The nail sections, operating in conjunction with the beams of the plane change region 134 being oriented along different planar regions, enables the first flexible finger 104 and the second flexible finger 106 to adapt and conform to the shape of external objects such that the robotic finger mechanism 100 can maintain contact over objects having a variety of different properties, e.g., objects that are wet, rigid, soft, and so forth. Further, the robotic finger mechanism 100 can operate to grasp and maintain contact with an external object having dimensions that are smaller than the example object 204 at all torque levels. Further, the flat surfaces in the nail sections of the flexible fingers, operating in conjunction with the beams in the plane change region 134, enables these fingers to effectively grasp and maintain contact with objects having thin surfaces such as, e.g., handles of drawers, door handles, paper plates, paper cups, and so forth. This capability enables the robotic system described herein to be effective in grasping and maintaining contact with objects that are disproportionately large as compared to the robotic system 100, in addition to objects having asymmetric and symmetric shapes, e.g., drawer handles, cups, plates, and so forth.

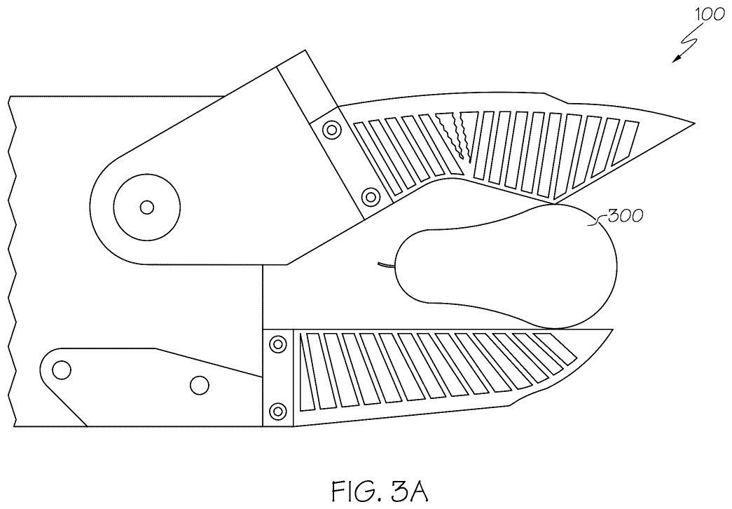

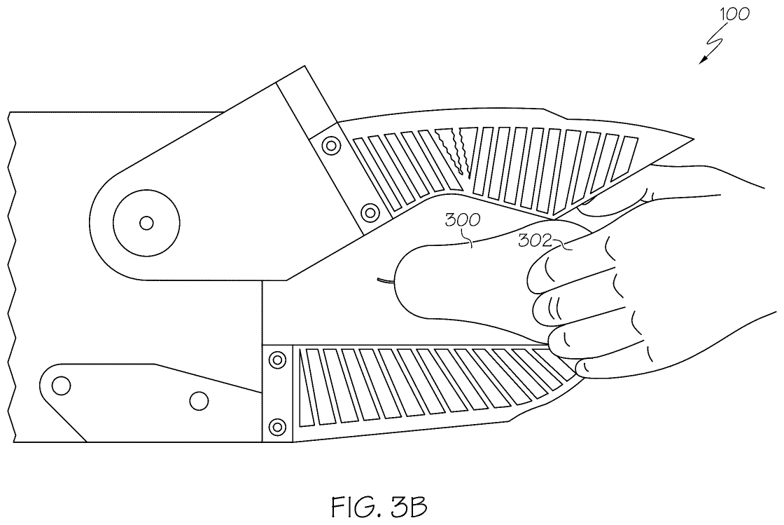

FIG. 3A depicts the robotic finger mechanism 100 grasping and maintaining contact with an example object 300, according to some aspects described and illustrated herein. Specifically, the example object 300 in FIG. 3B has dimensions that are less than the dimensions of the example object 204 of FIG. 2B. In aspects, the robotic finger mechanism 100 can be controlled by the motor of the robot 108 e.g., at all torque levels as compared with other designs, to grasp and maintain control over the example object 300. FIG. 3B illustrates an example operation of the robotic finger mechanism 100, according to some aspects described and illustrated herein. Specifically, FIG. 3B depicts a scenario in which the robotic finger mechanism 100 maintains a firm grasp or control over the example object 300 despite an operator 302 applying an amount of pressure to dislodge the example object 300 from the grasp of the robotic finger mechanism 100.

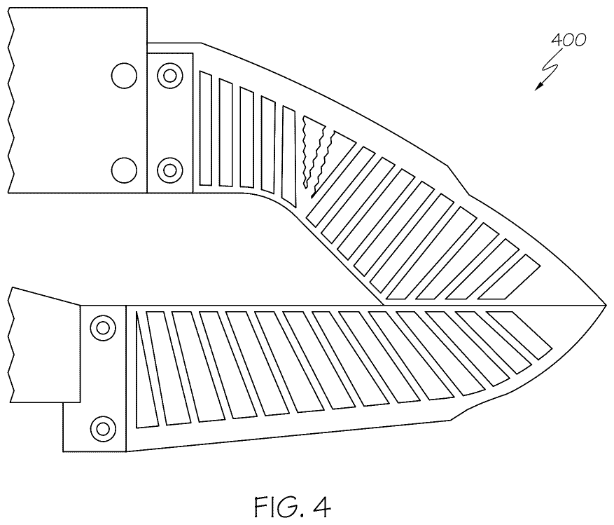

FIG. 4 depict another example aspect or configuration of the robotic finger mechanism 100, according to some aspects described and illustrated herein. Specifically, an example configuration 400 corresponds to a version of the robotic finger mechanism 100 as described in the present disclosure that lacks the support protrusion 112 or the additional support protrusion 114. In aspects, despite the lack of the support protrusion 112, the example configuration 400 operates similar to the other design illustrated in FIG. 1-3B and described in detail above. Specifically, the example configuration 400 of the robotic mechanism described herein also operates to grasp and maintain contact with objects having dimensions that are proportional to the dimensions of the example configuration 400 and with objects that are disproportional to the dimensions of the example configuration 400.

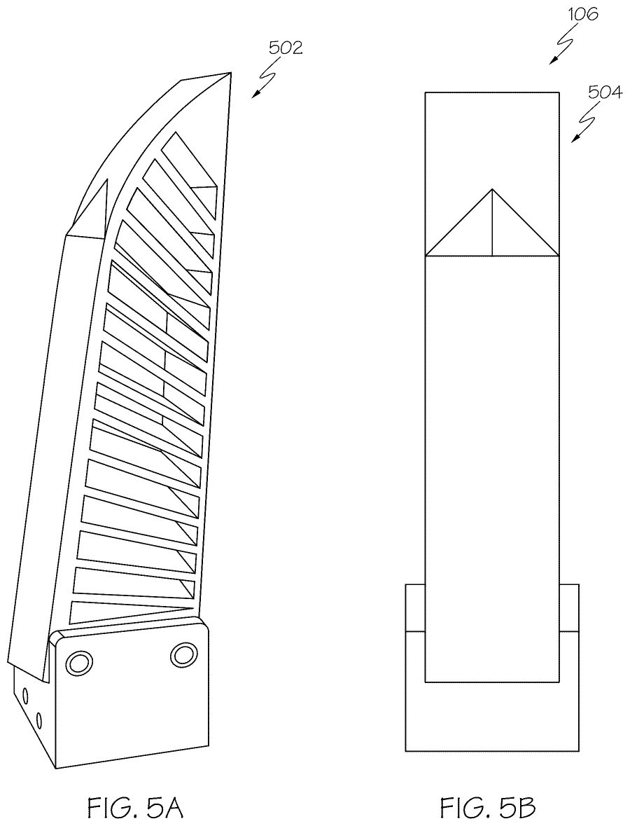

FIGS. 5A and 5B depict different views of the second flexible finger 106 according to some aspects described and illustrated herein. Specifically, FIG. 5A depicts a side view 502 and FIG. 5B depicts a frontal view 504 of the second flexible finger 106. It is noted that the second flexible finger 106 as depicted in FIGS. 5A and 5B does not include an adhesive tape or any other adhesive materials disposed on the nail section of the finger. It is noted, however, that the second flexible finger 106 does include the spinal layer 142 as illustrated in FIG. 1C and described above. Further, in aspects, the second flexible finger 106 lacks a region in which one or more of the plurality of beams are oriented along a different plane relative to at least another one of the plurality of beams.

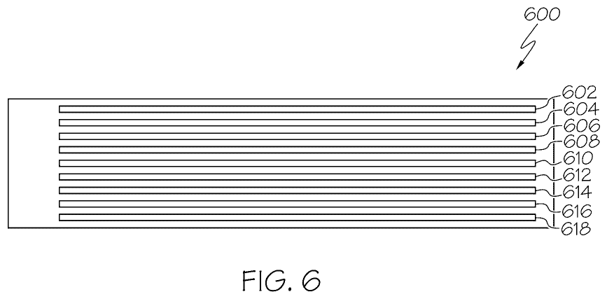

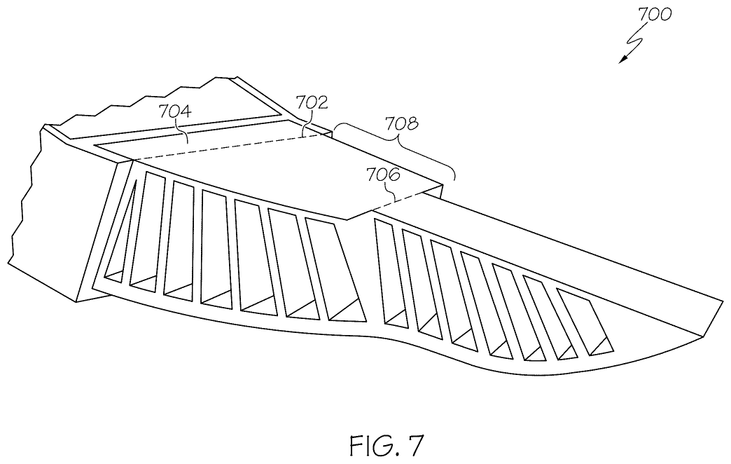

FIG. 6 depicts another example flexible finger 600 of the robotic finger mechanism 100 of the present disclosure, according to some aspects described and illustrated herein. The example flexible finger 600 in FIG. 6 includes a plurality of perforations (perforations 602, 604, 606, 608, 610, 612, 614, 616, and 618) positioned at various locations on a bottom surface of example flexible finger 600. The number of perforations can vary. While nine perforations are currently disposed on the bottom surface of the example flexible finger 600, fewer or more perforations can be disposed on the bottom surface. Further, in aspects, the width of each of the plurality of perforations can vary such that fewer perforations can be disposed on the bottom surface with each perforation having a larger width. Alternatively, additional perforations (e.g., more than 9 perforations) with smaller dimensions (e.g., smaller widths) are also contemplated. In aspects, one or more perforations can be disposed on a bottom surface of the example finger 600 such that each of the one or more perforations extends from an end of the bottom surface to another location proximal to another end of the bottom surface. Further, the plurality of perforations can be arranged on the bottom surface of the finger such that these perforations are oriented according to a parallel configuration, as illustrated in FIG. 6. The perforations improve the compliance capability of the example finger 600 such that the finger is able to grasp and maintain contact with an external object in an improved manner. For example, the perforations enable the example flexible finger 600 to operate in a manner that is similar to a human finger, namely deform and conform to the shape of an external object upon contacting the outer surface of an external object. The perforations also provide the added benefit of enabling localized deformations on the surfaces of the example finger 600 instead of a deformation of the entire example finger 600.

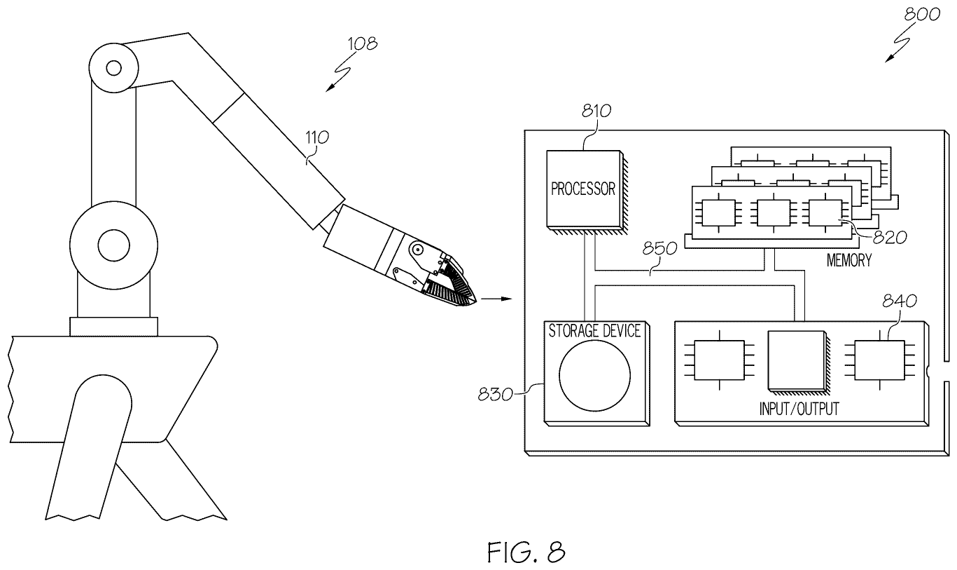

FIG. 7 depicts another example flexible finger 700 of the robotic finger mechanism 100 of the present disclosure, according to some aspects described and illustrated herein. The example flexible finger 700 has characteristics that are similar to those of other robotic flexible finger aspects described herein, but with some differences. While the example flexible finger 700 includes example beams 701 (similar to other finger designs described herein), which are oriented in accordance with a particular configuration, a width 702 of a portion of a bottom surface of the flexible finger 700 is larger as compared to other parts of the example flexible finger 700. Further, as illustrated in FIG. 7, the width of the example flexible finger 700 is largest at an end 704 and progressively reduces along a region 708. In aspects, the width towards an end of the region 708, which corresponds to approximately the middle of the example finger 700, is the smallest within the region 708. The larger width of at least a part of the bottom surface of the example flexible finger 700 enables it to make better contact with a larger surface area of an external object, which in turn enables the example finger 700 to establish and maintain contact and facilitate a firm grasping of the external object.

FIG. 8 illustrates a schematic diagram of an example computing system 800 that can correspond to, e.g., a microprocessor that is built as part of the robot 108, that is configured to control operation of one or more actuators or motors that control operation of the flexible fingers described herein. Further, the example computing system 800 is robot agnostic in that it can be implemented as part of robots having various shapes, sizes, dimensions, and differing mechanical and electromechanical capabilities. Further, the example computing system 800 can be operable to control the movement of robotic fingers installed as part of the robots having various shapes, sizes, dimensions, and differing mechanical and electromechanical capabilities. The example computing system 800 includes a processor 810, a memory 820, a storage device 830, and an input/output device 840. The components 810, 820, 830, 840 are interconnected using a system bus 850. The processor 810 is capable of processing instructions for execution within the example computing system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the example computing system 800. In one implementation, the memory 820 is a computer-readable medium. In one implementation, the memory 820 is a volatile memory unit. In another implementation, the memory 820 is a non-volatile memory unit. The storage device 830 is capable of providing mass storage for the example computing system 800. In one implementation, the storage device 830 is a computer-readable medium (e.g., a non-transitory computer readable medium).

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and various steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims. A number of implementations of the present disclosure have been described. Nevertheless, it will be understood that various modifications can be made without departing from the spirit and scope of the present disclosure. Accordingly, other implementations are within the scope of the following claims.

Further non-limiting aspects or embodiments are set forth in the following numbered aspects:

### Aspect 1

A robotic system comprising a support structure, and a first flexible finger and a second flexible finger, wherein a first end of the first flexible finger is fastened to a location on the support structure and an additional first end of the second flexible finger is fastened to an additional location on the support structure, the first flexible finger including a flexible support member disposed on a portion of an outer surface of the first flexible finger and extending from the first end of the first flexible finger to a position on the outer surface of the first flexible finger, and a plurality of flexible beams disposed on a respective plurality of positions located along an interior surface of the first flexible finger, each of a first subset of the plurality of flexible beams oriented relative to a first plane, and each of a second subset of the plurality of flexible beams oriented relative to a second plane.

### Aspect 2

The robotic system of claim 1, wherein the first plane is different from the second plane.

### Aspect 3

The robotic system of aspect 1, wherein the second flexible finger including a plurality of additional flexible beams disposed on an additional respective plurality of positions located along an additional interior surface of the second flexible finger.

### Aspect 4

The robotic system of aspect 1, further comprising a support protrusion that extends, from a part of the location on the support structure to which the first flexible finger is fastened, along an orientation that is parallel to the outer surface of the flexible support member.

### Aspect 5

The robotic system of aspect 4, wherein the support protrusion is disposed on an outer surface of the flexible support member that is disposed on the outer surface of the first flexible finger.

### Aspect 6

The robotic system of aspect 1, wherein the first flexible finger and the second flexible finger having a deformation property that is higher than an additional deformation property of the support structure.

### Aspect 7

The robotic system of aspect 1, the first flexible finger includes a plurality of perforations.

### Aspect 8

The robotic system of aspect 7, wherein each perforation of the plurality of perforations on the first flexible finger extends from an end of a bottom surface of the first flexible finger to another end of the bottom surface.

### Aspect 9

The robotic system of aspect 7, wherein at least one of the plurality of perforations is positioned parallel to at least an additional one of the plurality of perforations.

### Aspect 10

The robotic system of aspect 1, wherein the second flexible finger includes a plurality of perforations.

### Aspect 11

The robotic system of aspect 10, wherein each perforation of the plurality of perforations on the second flexible finger extends from an end of a bottom surface of the second flexible finger to another end of the bottom surface of the second flexible finger.

### Aspect 12

The robotic system of aspect 11, wherein at least one of the plurality of perforations is positioned parallel to at least an additional one of the plurality of perforations.

### Aspect 13

A robotic system comprising: a support structure, and a first flexible finger and a second flexible finger, wherein a first end of the first flexible finger is fastened to a location on the support structure and an additional first end of the second flexible finger is fastened to an additional location on the support structure, the first flexible finger including: a flexible support member disposed on a portion of an outer surface of the first flexible finger and extending from the first end of the first flexible finger to a position on the outer surface of the first flexible finger, and a plurality of flexible beams disposed on a respective plurality of positions located along an interior surface of the first flexible finger.

### Aspect 14

The robotic system of aspect 13, wherein each of the plurality of flexible beams are oriented at a respective angle relative to the interior surface of the first flexible finger.

### Aspect 15

The robotic system of aspect 14, wherein the second flexible finger including a plurality of additional flexible beams disposed on an additional respective plurality of positions located along the interior surface of the second flexible finger.

### Aspect 16

The robotic system of aspect 15, wherein each of the additional flexible beams are oriented at a respective angle relative to the interior surface of the second flexible finger.

### Aspect 17

The robotic system of aspect 16, wherein: the first flexible finger includes a plurality of perforations, each perforation of the plurality of perforations on the first flexible finger extends from an end of a bottom surface of the first flexible finger to another end of the bottom surface of the first flexible finger, and at least one of the plurality of perforations is positioned parallel to at least an additional one of the plurality of perforations.

### Aspect 18

The robotic system of aspect 17, wherein: the second flexible finger includes a plurality of perforations, and wherein each perforation of the plurality of perforations on the second flexible finger extends from an end of a bottom surface of the second flexible finger to another end of the bottom surface of the second flexible finger.

### Aspect 19

The robotic system of aspect 18, wherein at least one of the plurality of perforations positioned parallel to at least an additional one of the plurality of perforations.

### Aspect 20

A flexible robotic finger comprising flexible beams disposed on a respective plurality of positions located along interior surfaces of the flexible robotic finger, an end of each of the flexible beams disposed on a first interior surface of the interior surfaces of the flexible robotic finger and another end of each of the flexible beams disposed on a second interior surface of the interior surfaces of the flexible robotic finger, and each of a first subset of the flexible beams oriented relative to a first plane, and each of a second subset of the flexible beams oriented relative to a second plane.

What is claimed is:

1. A robotic system comprising:
a support structure; and
a first flexible finger and a second flexible finger;
wherein a first end of the first flexible finger is fastened to a location on the support structure and an additional first end of the second flexible finger is fastened to an additional location on the support structure;
the first flexible finger including:
a flexible support member disposed on a portion of an outer surface of the first flexible finger and extending from the first end of the first flexible finger to a position on the outer surface of the first flexible finger, and
a plurality of flexible beams disposed on a respective plurality of positions located along an interior surface of the first flexible finger,
each of a first subset of the plurality of flexible beams oriented relative to a first plane, and
each of a second subset of the plurality of flexible beams oriented relative to a second plane.

2. The robotic system of claim 1, wherein the first plane is different from the second plane.

3. The robotic system of claim 1, wherein the second flexible finger including a plurality of additional flexible beams disposed on an additional respective plurality of positions located along an interior surface of the second flexible finger.

4. The robotic system of claim 1, further comprising a support protrusion that extends, from a part of the location on the support structure to which the first flexible finger is fastened, along an orientation that is parallel to the outer surface of the flexible support member.

5. The robotic system of claim 4, wherein the support protrusion is disposed on an outer surface of the flexible support member that is disposed on the outer surface of the first flexible finger.

6. The robotic system of claim 1, wherein the first flexible finger and the second flexible finger having a deformation property that is higher than a deformation property of the support structure.

7. The robotic system of claim 1, the first flexible finger includes a plurality of perforations.

8. The robotic system of claim 7, wherein each perforation of the plurality of perforations on the first flexible finger extends from an end of a bottom surface of the first flexible finger to another end of the bottom surface.

9. The robotic system of claim 7, wherein at least one of the plurality of perforations is positioned parallel to at least an additional one of the plurality of perforations.

10. The robotic system of claim 1, wherein the second flexible finger includes a plurality of perforations.

11. The robotic system of claim 10, wherein each perforation of the plurality of perforations on the second flexible finger extends from an end of a bottom surface of the second flexible finger to another end of the bottom surface of the second flexible finger.

12. The robotic system of claim 11, wherein at least one of the plurality of perforations is positioned parallel to at least an additional one of the plurality of perforations.

13. A robotic system comprising:
a support structure; and
a first flexible finger and a second flexible finger;
wherein a first end of the first flexible finger is fastened to a location on the support structure and an additional first end of the second flexible finger is fastened to an additional location on the support structure;
the first flexible finger including:
a flexible support member disposed on a portion of an outer surface of the first flexible finger and extending from the first end of the first flexible finger to a position on the outer surface of the first flexible finger, and
a plurality of flexible beams disposed on a respective plurality of positions located along an interior surface of the first flexible finger.

14. The robotic system of claim 13, wherein each of the plurality of flexible beams are oriented at a respective angle relative to the interior surface of the first flexible finger.

15. The robotic system of claim 14, wherein the second flexible finger including a plurality of additional flexible beams disposed on an additional respective plurality of positions located along the interior surface of the second flexible finger.

16. The robotic system of claim 15, wherein each of the additional flexible beams are oriented at a respective angle relative to the interior surface of the second flexible finger.

17. The robotic system of claim 14, wherein:
the first flexible finger includes a plurality of perforations;
each perforation of the plurality of perforations on the first flexible finger extends from an end of a bottom surface of the first flexible finger to another end of the bottom surface of the first flexible finger; and
at least one of the plurality of perforations is positioned parallel to at least an additional one of the plurality of perforations.

18. The robotic system of claim 17, wherein:
the second flexible finger includes a plurality of perforations; and
wherein each perforation of the plurality of perforations on the second flexible finger extends from an end of a bottom surface of the second flexible finger to another end of the bottom surface of the second flexible finger.

19. The robotic system of claim 18, wherein at least one of the plurality of perforations positioned parallel to at least an additional one of the plurality of perforations.

20. A flexible robotic finger comprising:
flexible beams disposed on a respective plurality of positions located along interior surfaces of the flexible robotic finger;
an end of each of the flexible beams disposed on a first interior surface of the interior surfaces of the flexible robotic finger and another end of each of the flexible beams disposed on a second interior surface of the interior surfaces of the flexible robotic finger; and
each of a first subset of the flexible beams oriented relative to a first plane, and
each of a second subset of the flexible beams oriented relative to a second plane.
